(19) United States
(12) Patent Application Publication
(10) Pub. No.: US 2009/0132837 A1
(43) Pub. Date: May 21, 2009

(54) System and Method for Dynamically Selecting Clock Frequency

(75) Inventor: Santosh Kumar, Santa Clara, CA (US)

Correspondence Address: The TPL Group, 20400 Stevens Creek Blvd., Fifth Floor, Cupertino, CA, 95014, US

(73) Assignee: MCM PORTFOLIO LLC, Cupertino, CA (US)

(21) Appl. No.: 11/941,021

(22) Filed: Nov. 15, 2007

(51) Int. Cl. G06F 1/32; G06F 1/12

(52) U.S. Cl. 713/320; 713/400

(57) ABSTRACT

A system and method for dynamically changing the clock frequency of a system clock is disclosed. The invention includes selecting a peripheral interface clock signal from a plurality of currently active peripheral interface clock signals, each operating at a particular frequency. The selected peripheral interface clock signal operates at the highest frequency of the plurality of currently active peripheral interfaces clock signals. Once selected, the frequency of the system clock is set equal to the frequency of the selected peripheral interface clock signal.

### BACKGROUND OF THE INVENTION

1. Field of the Invention

This invention relates generally to the clock frequency of a processing system, and more particularly to dynamically selecting a clock frequency for a processing system from a plurality of peripheral interface clock frequencies.

2. Description of the Related Art

Today, processing systems are capable of communicating with a wide range of peripheral interfaces, such as Ethernet interfaces, Universal Serial Bus (USB) interfaces, and Serial ATA (SATA) interfaces. Using the mechanism called hot plugging where the processing system detects when peripheral devices are removed or connected, peripheral devices can be connected or removed from a processing system without powering down the processing system. However, each peripheral interface may employ different communication protocols requiring the peripheral interface and the processing system to operate at different clock frequencies to transmit and receive data. Unfortunately, conventional processing systems generally cannot communicate simultaneously with multiple peripheral devices using different communication protocols.

For example, a typical USB peripheral device operates at frequency of 60 MHz and a typical SATA peripheral device operates at frequency of 150 MHz. A conventional processing system generally is required to operate at a frequency of 60 MHz in order to support the USB device and at an operating frequency of 150 MHz to support the SATA device. Unfortunately, when the processing system is communicating with the USB device at an operating frequency of 60 MHz, problems can occur when another peripheral device operating at different frequencies is connected to the processing system. For example, if the USB device is disconnected and the SATA device is connected, the processing system in the conventional system is unable to support the operating frequency required by the SATA peripheral interface because of the change in operating frequency. Hence, conventional processing systems are required to be powered down before changing the operating frequency of any peripheral interfaces in order to change operating frequency.

Thus, although conventional processing systems implementing hot plugging are capable of connecting and disconnecting peripheral devices, they fail to adjust the operating clock frequency of the system processor dynamically. As a result, problems are experienced when peripheral devices operating at differing frequencies are dynamically connected to such processing systems.

In view of the foregoing, there is a need for processing systems and methods for adjusting the operating clock frequency of such processing systems dynamically. In general, what is needed are processing systems that provide a mechanism to adjust the operating clock frequency of the processing system dynamically based on the peripheral devices connected to the processing system without powering down the processing system.

### SUMMARY OF THE INVENTION

Broadly speaking, the present invention addresses this needs by providing a system for dynamically selecting from a plurality of predetermined peripheral interface clock frequencies, a clock frequency for the processing system. In one embodiment a method for dynamically changing clock frequency of a system clock is disclosed. The method includes selecting a peripheral interface clock signal, from a plurality of currently active peripheral interface clock signals, operating at a particular frequency. Once selected, the frequency of the system clock is set equal to the frequency of the selected peripheral interface clock signal. The selected peripheral interface clock signal can operate at either the highest frequency or lowest frequency of the plurality of currently active peripheral interfaces clock signals, depending on the current settings of the system. In general, each peripheral interface clock signal is an output of a peripheral interface. As such, non-selected peripheral interfaces can be disabled once the frequency of the system clock is set and provided to the processing system, thus allowing the processing system to operate at the frequency of the selected peripheral interface clock signal.

In an additional embodiment, a system for dynamically changing clock frequency of a system clock is disclosed. The system includes a plurality of peripheral interfaces, each operating at a particular frequency. Coupled to each peripheral interface is a clock selection circuit that provides a system clock signal. In addition, a state machine is coupled to the each peripheral interface and to the clock selection circuit. In operation, the state machine selects an active peripheral interface that is operating at the highest clock frequency. The state machine then commands the clock selection circuit to set the frequency of the system clock to the frequency of the selected peripheral interface. Optionally, the system can include a plurality of clock generation circuits each coupled to a peripheral interface. Each clock generation circuit provides a clock signal at a particular frequency to a peripheral interface.

A further method for dynamically changing clock frequency of a system clock is disclosed in an additional embodiment of the present invention. The method includes monitoring a plurality of inactive and active peripheral interface clock signals to detect a change in status in any peripheral interface clock signal. When a change in status is detected, a peripheral interface clock signal is selected from the plurality of currently active peripheral interface clock signals. As above, the selected peripheral interface clock signal operates at the highest frequency of the active peripheral interfaces clock signals. Once selected, the system clock frequency is set equal to the frequency of the selected peripheral interface clock signal, and the non-selected peripheral interface clock signals are disabled. In this manner, embodiments of the present invention adjust the operating clock frequency of the processing system dynamically. The embodiments adjust the operating clock frequency of the processing system dynamically based on the peripheral devices connected to the system without requiring the system to power down. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing a system for dynamically selecting a clock frequency for a processing system, in accordance with an embodiment of the present invention;

FIG. 2 is a flowchart showing a method for dynamically changing the clock frequency of the system clock provided to the processing system, in accordance with an embodiment of the present invention;

FIG. 3 is a table showing exemplary conditions and peripheral interface selections based on peripheral clock frequency and peripheral interface status, in accordance with an embodiment of the present invention;

FIG. 4 is a flowchart showing a method for state machine operation when actively communicating with one or more peripheral interfaces, in accordance with an embodiment of the present invention; and

FIG. 5 is a flowchart showing a method for operation of the state machine when the processing system is not actively communicating with any peripheral interface, in accordance with an embodiment of the present invention.

### DETAILED DESCRIPTION OF THE PREFERRED EMBODIMENTS

An invention is disclosed for dynamically selecting the clock frequency of a processing system. In general, embodiments of the present invention dynamically select a clock frequency for the processing system from a plurality of predetermined peripheral interface clock frequencies. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

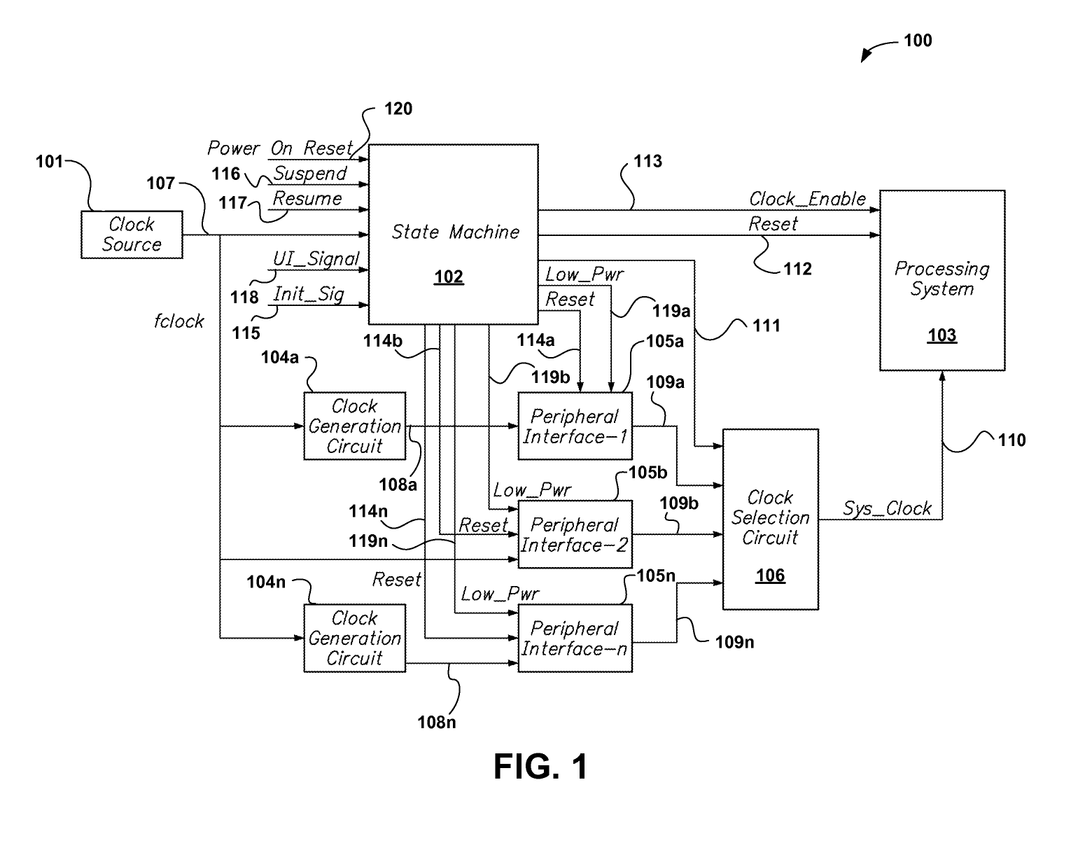

FIG. 1 is a block diagram showing a system 100 for dynamically selecting a clock frequency for a processing system 103, in accordance with an embodiment of the present invention. The system 100 includes a clock source 101 coupled to a state machine 102 and a plurality of clock generation circuits 104a-104n. The state machine 102 is further coupled to a processing system 103, a clock selection circuit 106, and a plurality of peripheral interfaces 105a-105n. Each peripheral interface 105a-105n is further coupled to a clock generation circuit 104a-104n and the clock selection circuit 106, which is also coupled to the processing system 103.

In operation, the clock source 101 provides an external clock frequency fclock 107 to the state machine 102, clock generation circuits 104a-104n, and optionally, directly to a peripheral interface, such as peripheral interface 105b. The clock generation circuits 104a-104n generate clock signals 108a-108n to support the communication of the peripheral interfaces 105a-105n. The clock generation circuits 104a-104n can be designed from any circuit capable of generating a clock frequency based on the external clock frequency fclock 107, such as PPL circuits.

Although the clock generation circuits 104a-104n generally provide clock signals 108a-108n to support the communication of the peripheral interfaces 105a-105n, some peripheral interfaces 105a-105n may not require a clock generation circuit 104. Depending on the clock frequency of the external clock fclock 107, a particular peripheral interface 105 may be able to use the external clock frequency fclock 107 directly. For example, peripheral interface 105b is directly coupled to the external clock fclock 107 without using clock generation circuitry because, in the example of FIG. 1, the frequency of the external clock fclock 107 provided by the clock source 101 matches the clock frequency required to support the communication of the peripheral interface 105b. Clock generation circuit 104a is coupled between the clock source 101 and the peripheral interface 105a because, in the example of FIG. 1, the clock frequency fclock 107 provided by the clock source 101 does not match the clock frequency required to support the communication peripheral interface 105a.

Each peripheral interface 105a-105n is further coupled to the clock selection circuit 106, which is also coupled to the state machine 102 and the processing system 103. The clock selection circuit 106 receives the peripheral clock signals 109a-109n from peripheral interfaces 105a-105n and a clock select signal 111 from the state machine 102. In addition, the clock selection circuit 106 provides a system clock 110 to the processing system 103 based on the clock select signal 111 received from the state machine 102.

More specifically, the clock selection circuit 106 selects a particular peripheral clock signal 109a-109n based on the clock select signal 111 received from the state machine 102. The clock select signal 111 can comprise 0 to n-1 bits and allows for 2n peripheral interfaces 105a-105n to be coupled to the clock selection circuitry 106. For example if the clock select signal 111 has 3 bits, eight peripheral interfaces 105a-105n can be coupled to the clock selection circuit 106. In this example, when the clock selection circuit 106 receives a clock select signal 111 of value 000, the processing system 103 is provided peripheral clock signal 109a as the system clock 110. Similarly if the clock selection circuit 106 receives a clock select signal 111 of value 001, the processing system 103 is provided peripheral clock signal 109b as the system clock 110.

The state machine 102 monitors the peripheral interfaces 105a-105n actively communicating with the processing system 103. On detecting a change in the status of a peripheral interface 105a-105n, the state machine 102 forces the processing system 103 into a known operating state using a reset signal 112 and commands the clock selection circuit 106 to change the system clock 110 provided to the processing system 103, as described in greater detail below.

In one embodiment, the state machine 102 can be configured to select either the highest or lowest frequencies of the active peripheral interfaces 105a-105n using the UI_signal 118. For example, in one embodiment, the state machine 102 commands the clock selection circuit 106 to provide the highest clock frequency value of the peripheral interfaces 105a-105n on receiving a value of ‘1’ from the UI_signal 118 and selects the lowest clock frequency on receiving a value of ‘0’ from the UI_signal 118. In addition, the state machine 102 can disable a clock enable signal 113 on detecting no active communication between the processing system 103 and all of the peripheral interfaces 105a-105n, as will be explained in greater detail below.

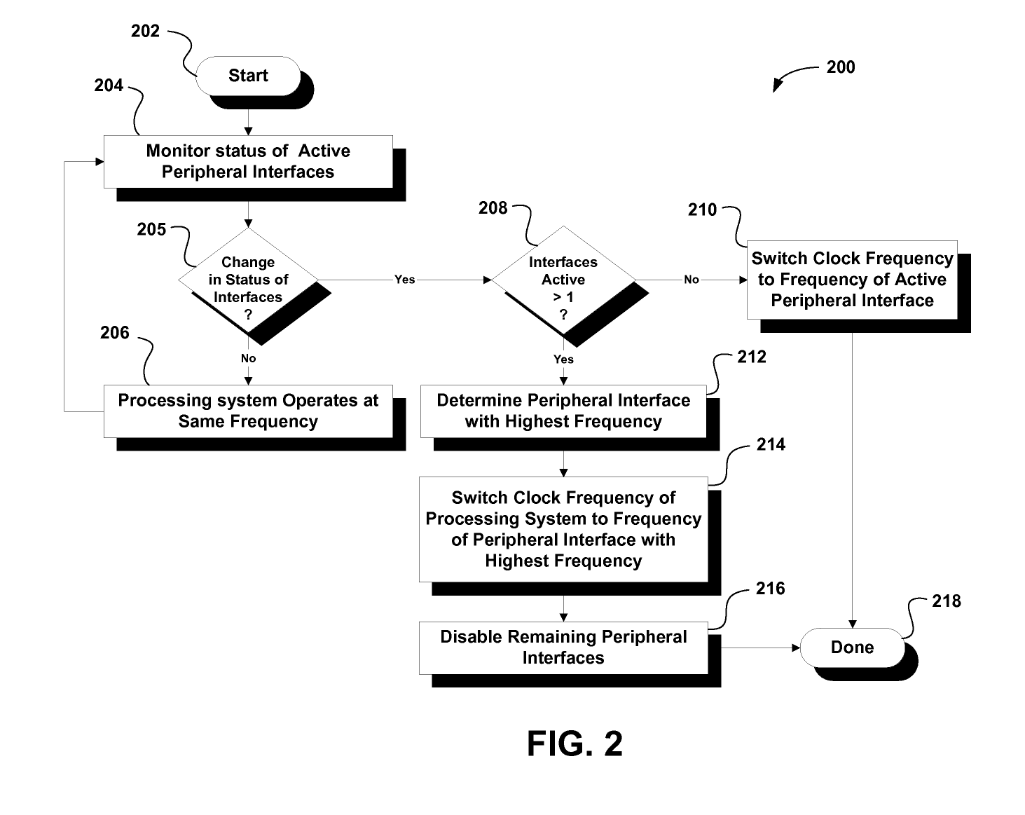

FIG. 2 is a flowchart showing a method 200 for dynamically changing the frequency of the system clock provided to the processing system, in accordance with an embodiment of the present invention. In an initial operation 202, preprocess operations are performed. Preprocess operation can include, for example, powering up the processing system, loading boot data, and other preprocess operations that will be apparent to those skilled in the art after reading of the present disclosure.

In operation 204, the status of the active peripheral interfaces is monitored. Referring to FIG. 1, the state machine 102 monitors the peripheral interfaces 105a-105n actively communicating with the processing system 103. By constantly monitoring the status of the peripheral interfaces 105a-105n, the state machine 102 can determine when a change in the status of any peripheral interfaces 105a-105n occurs. In this manner, state machine 102 can determine, for example, when a peripheral device is connect or removed from a particular peripheral interface 105a-105n.

Turning back to FIG. 2, a determination is made as to whether a change in status of any of the peripheral interfaces has occurred in operation 205. As discussed above, the state machine 102 monitors each peripheral interface 105a-105n to detect when a change in the status of a peripheral interface 105a-105n has occurred. If a change in status of any of the peripheral interfaces has occurred, the method 200 branches to operation 208. Otherwise, the method 200 continues with operation 206.

In operation 206, the processing system continues to operate at the same frequency. That is, when no change in status has occurred for any of the peripheral interfaces, the system clock remains the same. As a result, the processing system 103 continues to operate at the same frequency. The state machine 102 then continues monitoring the status of active peripheral interfaces in another monitor operation 204.

If a change in status occurs, a determination is made as to whether more than one peripheral interface is active, in operation 208. As discussed above, a plurality of peripheral interfaces 105a-105n can be included in the system. Hence, during operation 208, the state machine determines whether more than one peripheral interface is currently active. If more than one peripheral interface is currently active, the method 200 continues with operation 212. Otherwise, the method 200 branches to operation 210.

In operation 210, the clock frequency for the processing system is set to the frequency of the peripheral interface that is currently active. When there is a change in status of the peripheral interfaces 105a-105n and only one peripheral interface is currently active, the state machine instructs the clock selection circuit to set the system clock frequency to the frequency of the currently active peripheral interface.

However, if more than one peripheral interface is currently active, the peripheral interface with the highest performance is determined, in operation 212. Turning to FIG. 1, when a change in status is detected and more than one peripheral interface 105a-105n is currently active, the state machine 102 determines the peripheral interface 105a-105n having the highest clock frequency. As discussed previously, each peripheral interface 105a-105n can have a different clock frequency based on the clock signal provided, either directly from the clock source 101 or from a clock generation circuit 104a-104n. In operation 212, the state machine 102 determines which peripheral interface 105a-105n is both currently active and has the highest clock frequency of the currently active peripheral interfaces 105a-105n.

Referring back to FIG. 2, the clock frequency of the processing system is set to the frequency of the peripheral interface having the highest clock frequency, in operation 214. Turning to FIG. 1, the state machine 102 sends a series of commands by way of clock select signal 111 to the clock selection circuit 106, which changes the frequency of the system clock 110 to the frequency of the peripheral interface 105a-105n having the highest operating frequency as determined in operation 212. Once the system clock 110 frequency is stable, the processing system 103 begins using the new frequency. Although the example of FIG. 2 illustrates a process that selects the highest clock frequency, it should be noted that the state machine 102 can be set to select the lowest peripheral clock frequency, based on the UI_Signal 118 as described above.

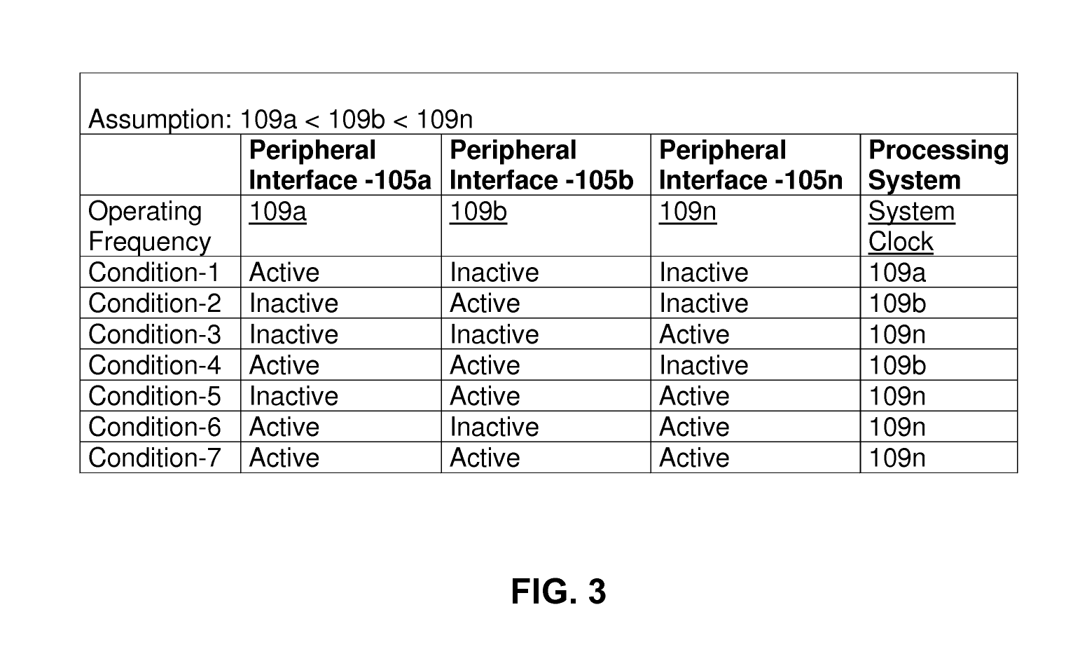

FIG. 3 is a table showing exemplary conditions and peripheral interface selections based on peripheral clock frequency and peripheral interface status, in accordance with an embodiment of the present invention. In the example of FIG. 3, the frequency of peripheral clock signal 109a of peripheral interface 105a is less than the frequency of peripheral clock signal 109b of peripheral interface 105b, which is less than the frequency of peripheral clock signal 109n of peripheral interface 105n. Although FIG. 3 illustrates one example of peripheral clock frequency relationships, it should be noted that any frequency relationships can be employed with embodiments of the present invention. In addition, FIG. 3 illustrates peripheral interface selections where the highest peripheral clock frequency is selected. However, it should be noted that the selection can be made based on selecting the lowest peripheral clock frequency, depending on the UI_Signal 118 as described above.

As shown in FIG. 3, in the example of condition-1, only the peripheral interface 105a is active, while the remaining peripheral interfaces 105b-105n are inactive. In this case, the state machine 102 commands the clock selection circuitry 106 to provide the peripheral clock signal 109a as the system clock 110 to the processing system 103. Similarly in condition-2 and condition-3, only the peripheral interface 105b and 105n are active respectively, and the remaining peripheral interfaces are inactive. In these cases, similar to condition-1, the state machine 102 commands the clock selection circuitry 106 to provide the peripheral clock signal 109b or 109n respectively as the system clock 110 to the processing system 103.

In the example of condition-4, both peripheral interfaces 105a and 105b are active. Here, the state machine 102 commands the clock selection circuitry 106 to provide the peripheral clock frequency 109b to the processing system 103 because the peripheral clock frequency 109b, which is required by the peripheral interface 105b, is higher than the peripheral clock frequency 109a, which is required by the peripheral interface 105a.

In the example of condition-5, both peripheral interfaces 105b and 105n are active. Here, the state machine 102 commands the clock selection circuitry 106 to provide the peripheral clock frequency 109n to the processing system 103 because the peripheral clock frequency 109n, which is required by the peripheral interface 105n, is higher than the peripheral clock frequency 109b, which is required by the peripheral interface 105b. Similarly, in the example of condition-6, both peripheral interface 105a and 105n are active. Here, the state machine 102 also commands the clock selection circuitry 106 to provide the peripheral clock frequency 109n to the processing system 103 because the peripheral clock frequency 109n is higher than the peripheral clock frequency 109a.

In the example of condition-7, peripheral interfaces 105a, 105b, and 105n are all active. In this case, the state machine 102 commands the clock selection circuitry 106 to provide the peripheral clock frequency 109n to the processing system 103 because the peripheral clock frequency 109n is higher than both peripheral clock frequency 109a and peripheral clock frequency 109b.

Referring back to FIG. 2, in operation 216, the remaining peripheral interfaces are disabled. Once the system clock 110 is set to the highest active peripheral clock frequency, the state machine 102 disables the remaining peripheral interfaces using the reset signals 114a-114n. That is, the state machine 102 sends reset signals 114a-114n to the remaining peripheral interfaces 105a-105n, which are not operating at the highest clock frequency. For example, in condition-7 of FIG. 3, peripheral interfaces 105a, 105b, and 105n are active. In addition to commanding the clock selection circuitry 106 to provide the peripheral clock frequency 109n to the processing system 103, the state machine activates reset signals 114a and 114b to peripheral interfaces 105a and 105b respectively to disable peripheral interfaces 105a and 105b.

The state machine 102 also may force one or more the peripheral interfaces 105a-105n into low power mode using the Low Power signals 119a-119n. For example in condition-4, both peripheral interface 105a and 105b are active and clock frequency 109b is provided to the processing system 103. Here, the state machine 102 activates the Low Power signal 119a to the peripheral interface 105a. Similarly in condition-7 and condition-6, the Low Power signals 119a and 119b to the peripheral interfaces 105a to 105b respectively are activated.

Post process operations are then performed in operation 218. Post process operations can include, for example, further monitoring of active peripheral interface status, further system clock frequency changing, and other post process operations that will be apparent to those skilled in the art after reading of the present disclosure.

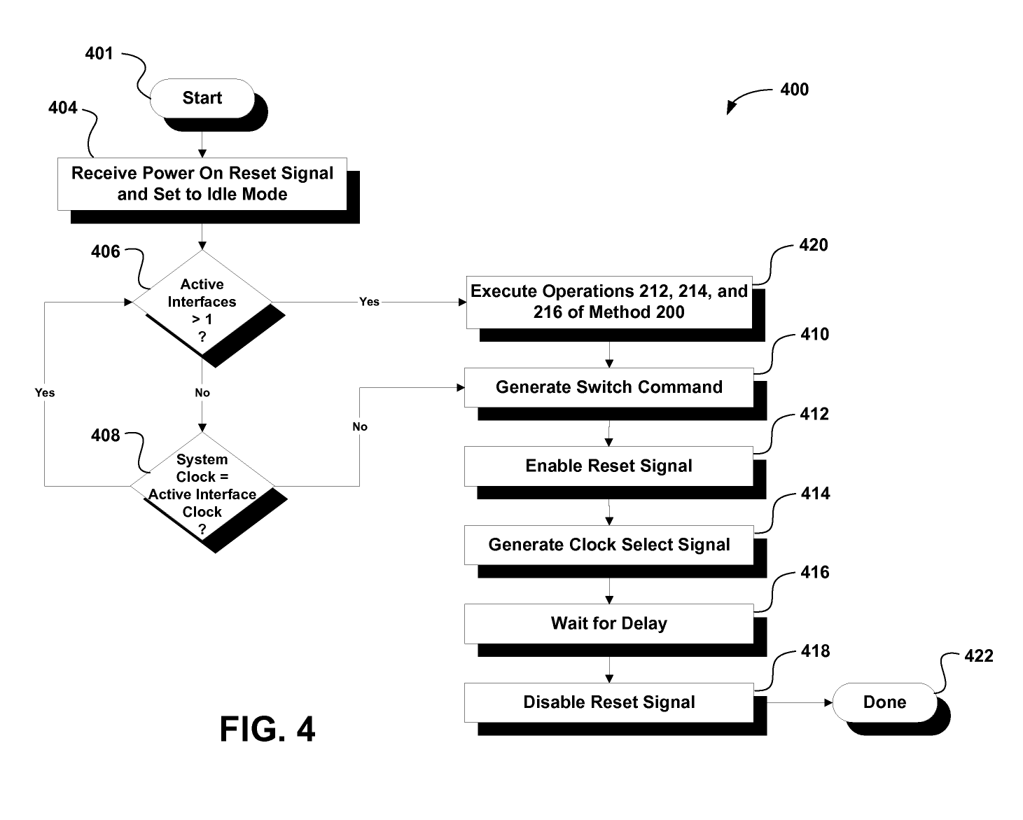

FIG. 4 is a flowchart showing a method 400 for state machine operation when actively communicating with one or more peripheral interfaces, in accordance with an embodiment of the present invention. In an initial operation 401, preprocess operations are performed. Preprocess operations can include, for example, selecting particular peripheral interface frequencies to support, and other preprocess operations that will be apparent to those skilled in the art after a careful reading of the present disclosure.

In operation 404, a power on reset signal is received and the state machine is set to idle mode. Turing to FIG. 1, on receiving the power on reset signal 120, the state machine 102 is programmed to operate in the initial power on operating mode and the Init_Sig signal 115 is applied to force the state machine 102 to an idle state. It should be noted that the Init_Sig signal 115 can be generated using firmware or internally generated by the state machine 102.

A decision is then made whether the number of active interfaces is greater than one or equal one, in operation 406. Here, the state machine 102 monitors the number of active peripheral interfaces 105a-105n. If the number of active interfaces is greater than one, the method continues to operation 420, where the state machine 102 executes the operations 212, 214 and 216 of method 200. The method then continues to operation 410. However, if the number of active interfaces is equal to one, the method continues to operation 408.

When the number of active interfaces is equal to one, a decision is made whether the frequency of the system clock being provided to the processing system is equal to the frequency of the peripheral interface clock currently active. The state machine 102 determines whether the frequency of the system clock 110 provided to the processing system 103 is the frequency required to support the currently active peripheral interface. For example, if peripheral interface 105a is the only active peripheral interface, the state machine 102 verifies whether the frequency of peripheral clock signal 109a is same as the frequency of the system clock 110. If the frequency of the system clock is equal to the frequency of the peripheral interface clock currently active, the state machine continues to monitor the number of active peripheral interfaces 105a-105n in another monitoring operation 406. However, if the frequency of the system clock is not equal to the frequency of the peripheral interface clock currently active, the method 400 continues to operation 410.

In operation 410, a switch command is generated. When the frequency of the system clock does not equal the frequency of the currently active peripheral interface, the state machine 102 generates a switch command. The state machine 102 then enables the reset signal 112 for the processing system 103 to force the processing system 103 into a known operating state, in operation 412. The state machine 102 also generates the clock select signal 111 to the clock selection circuitry 106, in operation 414. The frequency of the system clock 110 is switched to the new clock frequency after a predetermined delay time to ensure no glitches are generated while switching between different frequencies, in operation 416. After the predetermined delay time, the reset signal 112 is disabled to allow the processing system 103 to communicate with the new active peripheral interface, in operation 418. Postprocess operations are performed in operation 422. Postprocess operations can include, for example, application processing by the processing system, continued monitoring of peripheral interfaces via the state machine, and other postprocess operations that will be apparent to those skilled in the art after reading of the present disclosure.

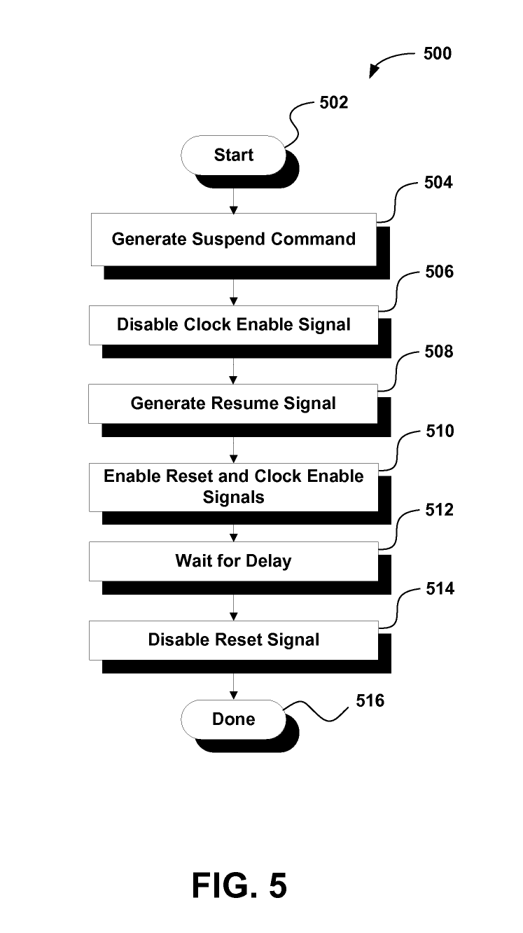

FIG. 5 is a flowchart showing a method 500 for operation of the state machine 102 when the processing system is not actively communicating with any peripheral interface, in accordance with an embodiment of the present invention. In an initial operation 502, preprocess operations are performed. Preprocess operations can include, for example, receiving a power of reset signal, further boot up operations, and other preprocess operations that will be apparent to those skilled in the art after reading of the present disclosure.

In operation 504, a suspend command is generated. When the processing system 103 is not actively communicating with any peripheral interface 105a-105n, the state machine 102 generates a suspend command 116 to force the system 100 into a power efficient mode. In addition, the clock enable signal 113 is disabled, in operation 506. In operation 508, the user or host generates a resume signal 117 enabling the state machine 102 to verify a change in status of any of the peripheral interfaces 105a-105n.

On detecting a change in the status of any of the peripheral interfaces 105a-105n, the state machine 102 enables the clock enable signal 113 and the reset signal 112 to force the processing system to operate in a known condition, in operation 510. A predetermined amount of time is waited, in operation 512, and the reset signal 112 is disabled to activate the processing system 103, in operation 514. Postprocess operations are then performed in operation 516. Postprocess operations can include, for example, detection of a change in status of a peripheral interface, determining the highest frequency of all active peripheral interfaces, setting the frequency of the system clock to the highest frequency of all active peripheral interfaces, and other postprocess operations that will be apparent to those skilled in the art after reading of the present disclosure.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for dynamically changing clock frequency of a system clock, comprising the operations of:
selecting a peripheral interface clock signal from a plurality of currently active peripheral interface clock signals, wherein each peripheral interface clock signal operates at a particular frequency; and
setting a frequency of a system clock equal to the frequency of the selected peripheral interface clock signal.

2. A method as recited in claim 1, wherein the selected peripheral interface clock signal operates at a highest frequency of the plurality of currently active peripheral interfaces clock signals.

3. A method as recited in claim 1, wherein the selected peripheral interface clock signal operates at the lowest frequency of the plurality of currently active peripheral interfaces clock signals.

4. A method as recited in claim 1, wherein each peripheral interface clock signal is an output of a peripheral interface.

5. A method as recited in claim 4, further comprising the operation of disabling non-selected peripheral interfaces.

6. A method as recited in claim 4, further comprising the operation of supplying a generated clock signal to a plurality of peripheral interfaces, wherein each generated clock signal is based on an external clock source.

7. A method as recited in claim 1, wherein the system clock is provided to a processing system, and wherein the processing system operates at a frequency of the selected peripheral interface clock signal.

8. A system for dynamically changing clock frequency of a system clock, comprising:
a plurality of peripheral interfaces, wherein each peripheral interface operates at a particular frequency;
a clock selection circuit coupled to each peripheral interface, the clock selection circuit providing a system clock signal; and
a state machine coupled to each peripheral interface and to the clock selection circuit, wherein the state machine selects an active peripheral interface operating at a highest clock frequency, and wherein the state machine commands the clock selection circuit to set a frequency of the system clock to the frequency of the active peripheral interface.

9. A system as recited in claim 8, further comprising a plurality of clock generation circuits each coupled to a peripheral interface, wherein each clock generation circuit provides a clock signal at a particular frequency to peripheral interface.

10. A system as recited in claim 9, wherein each clock generation circuit is coupled to an external clock source.

11. A system as recited in claim 8, further comprising a processing system coupled to the clock selection circuit and the state machine, wherein the system clock is provided to the processing system.

12. A system as recited in claim 11, wherein the state machine is capable of providing a reset signal to the processing system to force the processing system into a known state.

13. A system as recited in claim 8, wherein the state machine disables non-selected peripheral interfaces.

14. A system as recited in claim 13, wherein the state machine further places non-selected peripheral interfaces into a low power state.

15. A method for dynamically changing clock frequency of a system clock, comprising the operations of:
monitoring a plurality of inactive and active peripheral interfaces, having peripheral interface clock signals, to detect a change in status in one of the peripheral interface clock signals of the plurality of inactive and active peripheral interfaces, wherein each peripheral interface clock signal operates at a particular frequency;
selecting a peripheral interface clock signal from plurality of currently active peripheral interface clock signals when a change in status is detected, wherein the selected peripheral interface clock signal operates at a highest frequency of the active peripheral interface clock signals;
setting a frequency of a system clock equal to the frequency of the selected peripheral interface clock signal; and
disabling non-selected peripheral interface clock signals.

16. A method as recited in claim 15, wherein each peripheral interface clock signal is an output of a peripheral interface.

17. A method as recited in claim 16, further comprising the operation of disabling non-selected peripheral interfaces.

18. A method as recited in claim 16, further comprising the operation of supplying a generated clock signal to a plurality of peripheral interfaces, wherein each generated clock signal is based on an external clock source.

19. A method as recited in claim 15, wherein the system clock is provided to a processing system, whereby the processing system operates at a frequency of the selected peripheral interface clock signal.

20. A method as recited in claim 15, further comprising the operation of setting a processing system to a known state when setting the frequency of the system clock to the frequency of the selected peripheral interface clock signal.
